(19) United States
(12) Patent Application Publication
(10) Pub. No.: US 2018/0281653 A1
(43) Pub. Date: Oct. 4, 2018

(54) HYGIENE ACCESSORY FOR A PASSENGER SEAT AND METHOD FOR MAINTAINING A PASSENGER-TRANSPORT DEVICE

(71) Applicant: GUILHEM INNOVATIONS, Albias (FR)

(72) Inventors: Christian GUILHEM, Albias (FR); Marc GUILHEM, Mirabel (FR); Jacques GUILHEM, Montauban (FR)

(21) Appl. No.: 15/763,760

(22) PCT Filed: Sep. 28, 2016
(86) PCT No.: PCT/EP2016/073141

§ 371 Date: Mar. 27, 2018

(30) Foreign Application Priority Data
Sep. 29, 2015 (FR) 1559183

(51) Int. Cl. B60N 3/08; B60N 3/10; B65F 1/14

(52) U.S. Cl. CPC B60N 3/08; B65F 2220/1063; B65F 1/1415; B60N 3/102

(57) ABSTRACT

Disclosed is a hygiene accessory for a passenger seat of a passenger-transport device, including a waste container and a unit for hanging from the passenger seat formed by a hanging collar defining an aperture for passing waste. The hanging collar is suitable for being held around a cup-holder opening of a passenger seat and for supporting the waste container, which extends into the cup-holder opening under the aperture for passing waste and is kept concertinaed under the hanging collar prior to use by a temporary attachment suitable for allowing the container to unfold downwardly. Also disclosed is a method for maintaining a passenger-transport device by way of hygiene accessories as disclosed.

The invention relates to a hygiene accessory for a passenger seat of a passenger-transport device such as a vehicle, of the type comprising a waste container and means for hanging from a passenger seat. It relates to a method for maintaining a passenger-transport device such as a vehicle comprising passenger seats.

The passengers transported in passenger seats of passenger-transport devices such as vehicles—in particular public transport vehicles such as coaches, trains, aircraft, cruise ships or liners (passenger ships) . . . —individually generating small waste (sweet wrappers, wipes, sachets, napkins, handkerchiefs, chewing gum, cups . . . ) which need to be collected and disposed of at least after disembarkation of the passengers as the vehicle is being cleaned. It is also desirable to provide each passenger with at least one waste container allowing this waste to be collected during transportation.

In practice, despite various theoretical earlier proposals, this problem has not been properly solved on board most public transport vehicles for passengers such as coaches, trains, airliners, liners or cruise ships. In fact, the solutions retained in practice for maintaining these vehicles consist of requiring the cabin crew to regularly move along the passenger seats to collect the various waste in a bin bag and/or to thoroughly clean the vehicle after disembarkation of the passengers, gathering the remaining waste left in various pockets which may be provided on the passenger seats or on the floor. These practical solutions are unpleasant for staff and costly in terms of the workforce and the time the vehicle has to remain stationary.

It should be noted in this respect that the time required for cleaning after disembarkation of the passengers becomes a critical economic parameter for budget transport companies, the viability of which is directly linked to the turnaround speed of the vehicles at each destination. For example, budget airline companies have developed an economy of scale according to which the passengers which are to be embarked onto a plane are caused to wait in the gangway while the passengers of the preceding flight disembark the plane and the maintenance staff carry out a minimum level of cleaning of the plane. It thus proves to be the case that this cleaning is generally incomplete, much waste—in particular small, hard-to-see, waste—being left in the magazine pockets of the passenger seats, which is particularly unpleasant for the next passengers. For this reason, some airline companies have even removed the magazine pockets, following the example of coaches and trains. However, this solution is unsatisfactory, in particular because it limits the comfort of passengers.

In the past, passenger seats were provided with ashtrays in the armrests which could act as a bin for very small waste. These ashtrays have been removed as smoking has been forbidden on vehicles and, for reasons of cost and hygiene, they were problematic to clean. US 2001/0024056 proposes a solution consisting of again fitting plane seats with specific waste compartments or with a waste bag dispenser at the rear of the armrests. The solution has the same disadvantages: it is expensive and not totally satisfactory to those using it.

Other theoretical proposals were formulated a long time ago (cf. e.g. DE 22624437, GB 2370974) consisting of hanging a disposable waste bag behind the backrest of the passenger seats using hanging means generally comprising an adhesive and/or being particularly complex and/or specifically adapted to seat shapes or to a particular seat structure (and not compatible with other structures). These old theoretical proposals are not used in practice owing to their cost and especially their technical failings. Thus, when an adhesive is used as a hanging means it proves to be the case that either this adhesive is insufficiently strong to hold the waste bags or it leaves marks on the seat when the waste bas is removed after use. Furthermore, not all passenger seats are compatible with the attachment of an adhesive. For example, some passenger seats of public transport vehicles have a backrest entirely covered with fabric.

Thus the invention aims to overcome all of these disadvantages by proposing a simple, economical and comprehensive solution to the problem of the collection of small waste (i.e. of a maximum size, possible after squashing, of less than 10 cm) from passengers.

In this respect it aims in particular to propose a hygiene accessory for a passenger seat of a passenger-transport device such as a vehicle, in particular a public transport vehicle, allowing the collection of small waste, during transportation, in a manner which is pleasant and hygienic manner for the passengers, and which, moreover, is particularly inexpensive and permits rapid and economical maintenance of the passenger-transport device, in particular being compatible with the economy of scale of budget airline companies.

It also aims to propose such a hygiene accessory which is compatible with most passenger seats, in particular the passenger seats of public transport vehicles in use (planes, trains, coaches, cruise ships or ferries . . . ), whatever their shapes and structure, which does not require any modification to be made to the passenger seats, and which can be perfectly integrated into the passenger seats without changing the appearance or operation thereof.

It also aims to propose such a hygiene accessory which can be mass produced economically and which is easy and economical to handle, store and transport before use without the risk of impairment to the hygiene accessory.

It also proposes a method for maintaining (cleaning) a passenger-transport device such as a vehicle comprising passenger seats which have the same qualities.

Thus, the invention relates to a hygiene accessory for a passenger seat of a passenger-transport device comprising:
a waste container,
means for hanging from a passenger seat, comprising a hanging collar defining an aperture for inserting waste, the waste container being connected to the hanging collar in such a way that it can be hung below the latter and receive waste introduced into said waste-insertion aperture,
the hanging collar being adapted to be able to:
   be held around an opening,
   support the waste container extending into said opening below said waste-insertion aperture,
      characterised in that said means for hanging on a passenger seat are formed by said hanging collar.

The hanging collar of a hygiene accessory in accordance with the invention is adapted to be able:
to be held around an opening—in particular a cup-holder opening of a passenger seat, resting on a horizontal face extending around this opening,
support the waste container extending into said opening—in particular into said cup-holder opening—below said waste-insertion aperture.

In particular, a hygiene accessory in accordance with the invention has no hanging means at all other than the sole hanging collar and requires no specific device to fix or hang it on a passenger seat. The invention also permits the use of a cup-holder opening of a passenger seat in order to provide this seat with an individual waste container with the aid of a hygiene accessory in accordance with the invention which is particularly simple, inexpensive, disposable, quick and easy to install and remove, not preventing the normal use of the cup-holder opening (for placement of a cup) and not requiring any particular adaptation to the seat itself In fact, most passenger seats of passenger-transport devices such as public transport vehicles such as planes, trains, coaches . . . , and even the passenger seats of other vehicles (cars) are fitted with at least one cup-holder opening. However, the dimensions of the cup-holder openings of different known passenger transport vehicles are, if not all identical, in any case very similar so that they can be compatible with the disposable cups which are items produced in very large quantities with very similar, or even identical, dimensions.

Moreover, advantageously and in accordance with the invention, the waste container is kept folded up in an accordion-like fashion (concertinaed) below the hanging collar prior to use by a temporary attachment suitable for allowing it to unfold downwardly. From that point it fits perfectly into the passenger seat and is easy and economical to handle, store and transport prior to use without the risk of impairing the hygiene accessory.

The waste container being concertinaed below the hanging collar has a small thickness—in particular less than 2 cm, more particularly less than 1.5 cm, preferably between 0.5 cm and 1 cm—and does not change the general appearance of the passenger seat. It can be adapted to be inserted fully into the thickness of the cup-holder ring or the tray in which the cup-holder opening is provided, does not interfere with the operation thereof and can even improve its appearance. The temporary attachment which keeps it folded is, nevertheless, adapted to permit the waste container to unfold downwardly, this waste container thus being unfolded and extending through and below the cup-holder opening so that it can be used to receive waste.

Thus the means for hanging a hygiene accessory in accordance with the invention on a passenger seat are exclusively formed by said hanging collar which is adapted to support by itself the waste container and the waste it may contain, and to be able to cooperate with a passenger seat element defining a cup-holder opening to permit hanging of the hygiene accessory in accordance with the invention with respect to this element and thus with respect to the passenger seat. Similarly, the waste container itself is also adapted to permit it to cooperate with a cup-holder opening of a passenger seat, in particular so as to be able to pass through such an opening and to extend downwardly:
prior to use, in the concertinaed state, into the thickness of this element of the passenger seat,
during use in the downwardly unfolded state to permit reception of waste.

Numerous embodiment variations of the hanging collar of an accessory in accordance with the invention are possible, in particular with respect to its shape (in particular its peripheral shape around the cup-holder opening which can be, in particular, circular or polygonal, and/or its cross-section through an axial plane radial to the insertion aperture which can be rectangular, circular, oval or another shape), its dimensions, the material of which it is made and its mounting on the waste container.

In order to be able to be held around a cup-holder opening of a passenger seat and to come to rest on a horizontal face extending around the cup-holder opening, said hanging collar must, in particular, have radial dimensions greater than those of the cup-holder opening.

Throughout the text, a piece of material is said to be rigid when it does not deform under its own weight at least. The hanging collar must be sufficiently rigid to be able to hold the waste container and the waste it may contain around a cup-holder opening. In particular, advantageously and in accordance with the invention, said hanging collar is formed of at least one material selected from the group consisting of papers—in particular rigid papers—, card, non-woven textiles—in particular rigid non-woven textiles—and polymers—in particular rigid polymers. The hanging collar is e.g. formed of a rigid polymer selected from the group consisting of polyesters, polyacrylates (acrylic polymers), polycarbonates, polystyrenes, polyamides, mixtures and copolymers thereof.

Moreover, the hanging collar of an accessory in accordance with the invention can be of any shape. In certain embodiments, advantageously and in accordance with the invention, the hanging collar is formed by a circular O-ring. In other embodiments, advantageously and in accordance with the invention, said hanging collar is formed by a rigid circular planar washer.

The hanging collar of an accessory in accordance with the invention protrudes upwards, as an overthickness with respect to the cup-holder. The hanging collar is preferably adapted to have the smallest overthickness possible. Thus in certain embodiments, advantageously and in accordance with the invention, said hanging collar has a thickness of less than 3 mm, e.g. of the order of 1 mm to 1.5 mm. In this way, the accessory in accordance with the invention does not prevent the cup-holder (which can be a tray or a dedicated cup-holder support) from being folded vertically upwards against the seat backrest.

The insertion aperture defined by the hanging collar is preferably circular and has a diameter greater than or equal to 70 mm, and thus greater than or equal to a cup-holder opening diameter, preferably of the same order as this diameter. In certain embodiments, advantageously and in accordance with the invention, said hanging collar also extends radially outwards from said waste-insertion aperture by a radial extent of less than 90 mm and thus less than the radial extent of a foldable cup-holder support of a seat. In this way, the cup-holder support can be folded upwards against a seat backrest, or, in certain embodiments of a passenger seat, into a housing receiving this folded cup-holder support.

In particular, a hanging collar of an accessory in accordance with the invention advantageously has a peripheral outer diameter less than or equal to a peripheral outer diameter of a cup-holder ring articulated on the rear of a backrest of a passenger seat so as to be able to be folded upwards. This being the case, there is nothing, on the other hand, to prevent provision being made for the hanging collar to extend radially beyond the peripheral outer diameter of a cup-holder ring in the outwards direction, e.g. for it to comprise a flap adapted to cover the peripheral edge of a cup-holder ring, allowing the accessory to be held in place radially with respect to the cup-holder ring.

In certain advantageous embodiments of a hygiene accessory in accordance with the invention, said hanging collar has an outer diameter between 50 mm and 100 mm; and said waste-insertion aperture has a diameter between 40 mm and 90 mm.

Moreover, in certain advantageous embodiments of an accessory in accordance with the invention, the waste container is sufficiently thin not to prevent insertion of a cup into said waste-insertion aperture and into the cup-holder opening. In particular, the waste container has a thickness of less than 2 mm, typically of the order of 0.2 mm to 1 mm. Thus when the hygiene accessory in accordance with the invention is in place in a cup-holder opening it is still possible to place a cup in the insertion aperture so that the cup is supported by the cup-holder and closes the insertion aperture. Advantageously, in certain embodiments, the hanging collar has teeth extending radially, protruding towards the inside of said waste-insertion aperture.

These teeth can be triangular or rounded (e.g. in a half-disc shape) or of another shape. They permit a cup inserted into the insertion aperture to be wedged in place. They then facilitate removal of the unit formed by the cup and accessory in accordance with the invention from the cup-holder opening.

Moreover, the waste container of a hygiene accessory in accordance with the invention is fixed below the hanging collar, preferably in a non-removable manner, by any suitable fixing means, in particular by fixing means which can be selected from the group consisting of adhesive means, seams, welding and combinations thereof.

The waste container of a hygiene accessory in accordance with the invention is folded below the hanging collar prior to use but can also be rigid, at least in the folded state, in order to facilitate insertion thereof into a cup-holder opening. In certain embodiments of a hygiene accessory in accordance with the invention the waste container is preferably a flexible bag folded (prior to use for placement of waste therein) below said hanging collar.

In certain advantageous embodiments, the waste bag is kept concertinaed prior to use by a temporary attachment of one end of the waste bag below a frangible cover fixed to said hanging collar and covering said waste-insertion aperture. A frangible cover of this type can be formed of a simple synthetic film covering the insertion aperture and provided with a cut-out or cut-outs enabling this frangible cover to be torn easily. In a variation or in combination, at least one frangible sticking line can be placed inside the folded waste bag, this frangible sticking line connecting the folds formed by the folded waste bag.

In certain advantageous embodiments, the waste container is formed by a flexible cylinder closed by a base. A flexible cylinder of this type can be produced by transversely cutting a flexible cylindrical synthetic film In fact, such flexible cylindrical synthetic films are available at low cost in the form of coils and can be used to mass produce hygiene accessories in accordance with the invention by transversely cutting such a film into sections of desired length corresponding to that of a waste bag of an accessory in accordance with the invention. It will then suffice to rigidly fix one of the ends of each section to a hanging collar and the other end to a rigid base in order to close it. A waste container of this type is particularly inexpensive to manufacture and can be mass produced.

Advantageously and in accordance with the invention, this rigid base has an overall diameter less than or equal to that of said waste-insertion aperture (and of a cup-holder opening) and has visible printing (e.g. advertising and/or instructions for using the accessory in accordance with the invention). Thus, this printing is visible when the hygiene accessory in accordance with the invention is placed on a foldable cup-holder ring, this ring being folded vertically against the backrest of a passenger seat, the concertinaed waste container being inserted into the thickness of the cup-holder ring. The base is preferably more rigid than the flexible cylinder forming the waste container and is e.g. formed of a material similar or identical to that forming said hanging collar. It can be formed with the hanging collar by cutting out from a single piece in the form of a disc.

Furthermore, each constituent material of the waste container can be varied in numerous ways. In certain advantageous embodiments, the waste container is formed of at least one material selected from the group consisting of papers, fabrics, flexible non-woven textiles and polymers. The flexible cylinder forming the waste container of a hygiene accessory in accordance with the invention is e.g. formed of a flexible polymer selected from the group consisting of polyethylenes, elastomers, vinyl polymers, polyacrylates (acrylic polymers), polyamides, mixtures and copolymers thereof.

The waste container is preferably formed of a liquid-tight material. Nevertheless, there is nothing to prevent the provision of a material which is not liquid-tight, most of the individual waste of the passengers of a vehicle not being liquid and not containing liquid likely to run.

The invention also relates to a method for maintaining a passenger-transport device such as a vehicle comprising passenger seats each fitted with at least one cup-holder opening, characterised in that a hygiene accessory in accordance with the invention is made available to each passenger, and each hygiene accessory is collected after use.

Hygiene accessories in accordance with the invention can thus be made available to passengers upon embarkation, e.g. in a basket at the entrance to the vehicle. In a variation or in combination, advantageously and in accordance with the invention, prior to embarkation of the passengers, a hygiene accessory in accordance with the invention is placed in each cup-holder opening. After use, each hygiene accessory in accordance with the invention is collected i.e. simultaneously with the collection of the waste and cups by the crew during transportation. After disembarkation of the passengers, it is also possible to collect each hygiene accessory in accordance with the invention which has been left by a passenger in a cup-holder opening. In order to collect such a used accessory, it will suffice to remove it upwards out of the cup-holder opening. In this respect, it should be noted, that if a cup has been inserted into the waste-insertion aperture of a hygiene accessory in accordance with the invention in position in a cup-holder opening, the removal of the cup automatically causes removal of the hygiene accessory in accordance with the invention by reason of the teeth of the hanging collar which attach it to the cup.

The invention applies in particular to the maintenance (in particular to the cleaning) of public transport vehicles such as coaches, buses, rail vehicles (trains, trams . . . ), airliners, liners, cruise ships, etc.

The invention also relates to an accessory and a method which are characterised in combination by all or some of the features mentioned above or below.

Other aims, features and advantages of the invention will become apparent upon reading the following description given by way of non-limiting example and which makes reference to the attached figures in which:

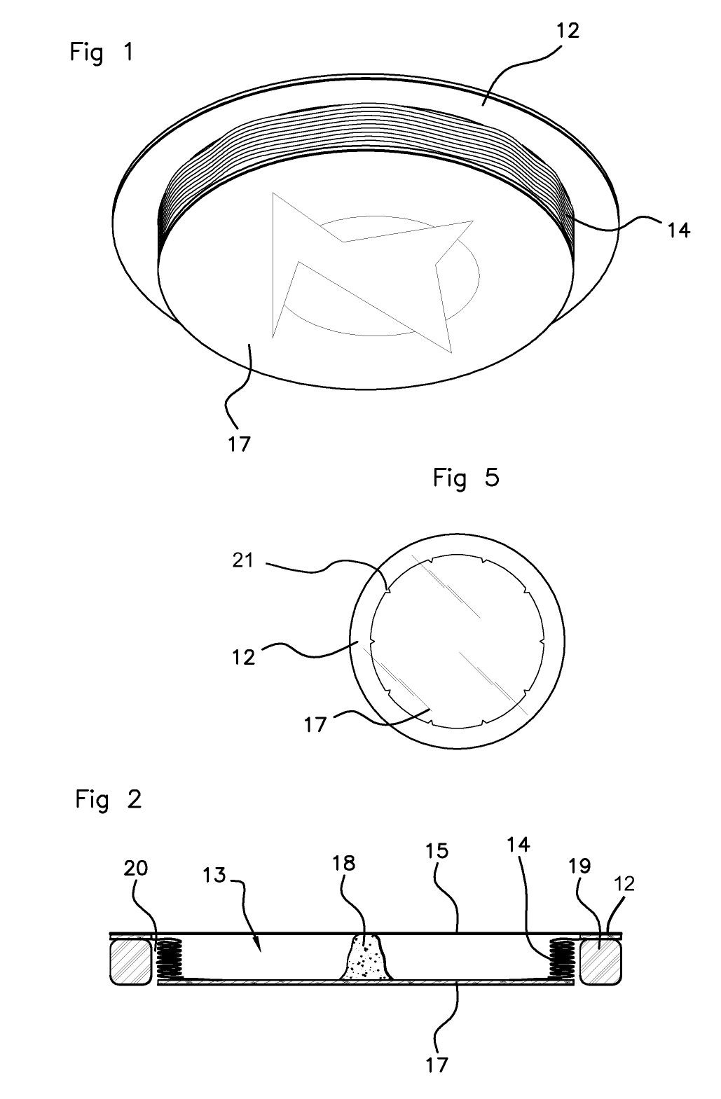

FIG. 1 is a schematic perspective view from below of a hygiene accessory in accordance with one embodiment of the invention illustrated in the folded state prior to use,

FIG. 2 is a schematic axial cross-sectional view of the hygiene accessory of FIG. 1 in place on a cup-holder ring,

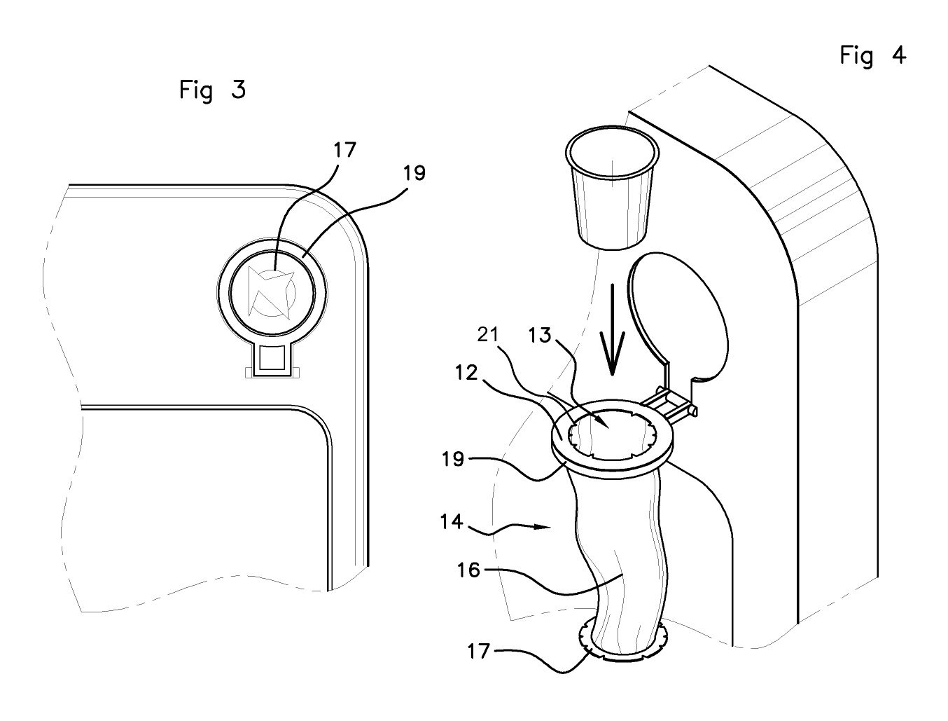

FIG. 3 is a schematic elevation of a cup-holder ring in the state folded upwards into its housing at the rear of the backrest of a passenger seat, and fitted with a hygiene accessory in accordance with the invention,

FIG. 4 is a schematic perspective view illustrating a hygiene accessory in accordance with one embodiment of the invention in use, the waste container being unfolded,

FIG. 5 is a schematic view from above of a cut-out piece permitting formation of the base and the hanging collar of a hygiene accessory in accordance with one embodiment of the invention.

The hygiene accessory in accordance with the invention for a passenger seat illustrated in the figures comprises a hanging collar 12 generally in the form of a flat washer defining an insertion aperture 13 which is generally circular, a flexible waste bag 14 fixed below the hanging collar 12 in a non-removable manner, e.g. by a seam and/or adhesion and/or welding and/or another fixing means, and an upper frangible cover 15 covering the insertion aperture 13 and fixed above the hanging collar 12.

The waste bag 14 is formed by a cylinder 16 of flexible material, preferably liquid-tight, e.g. of polyethylene or anther inexpensive polymeric synthetic material. One of the axial ends of the cylinder 16 is fixed below the hanging collar 12 around the insertion aperture 13. The connection between the hanging collar 12 and the flexible cylinder 16 is preferably liquid-tight, but there is nothing to prevent provision being made for it not to be liquid-tight in certain embodiments. In fact, it will suffice for it to be sufficiently strong to resist the weight of waste and for it not to allow this waste to exit the waste bag 14.

The other, lower end of the flexible cylinder 16 is closed by a disc forming the base 17 of the waste bag 14. This base 17 is preferably made of a rigid material which can be similar or identical to the material forming the hanging collar 12. The base 17 is non-removably fixed to the lower end of the flexible cylinder 16, preferably in a similar manner to the fixing of the cylinder 16 to the hanging collar, i.e. e.g. by a seam and/or adhesion and/or welding and/or any other fixing means. The connection between the base 17 and the flexible cylinder 16 is preferably liquid-tight, but there is nothing to prevent provision being made for it not to be liquid-tight in certain embodiments. In fact, it will suffice for it to be sufficiently strong to resist the weight of waste and for it not to allow this waste to exit the waste bag 14.

Initially, the hygiene accessory in accordance with the invention is manufactured with the flexible waste bag 14 folded below the hanging collar 12, the base 17 being temporarily attached to the frangible cover 15, e.g. by a spot of adhesive 18 as shown in FIG. 2 or by any other temporary attachment (seam and/or weld . . . ). The flexible cylinder 16 forming the waste bag 14 is concertinaed.

In this state, the thickness of the waste bag 14 is preferably adapted to correspond at least substantially to the thickness of a cup-holder ring 19. The base 17 and the cylinder 16 forming the waste bag 14 have an outer diameter slightly smaller than the inner diameter of a cup-holder opening 20. Thus, when the hygiene accessory is placed into a cup-holder opening 20 defined by such a cup-holder ring 19, the waste bag 14 is inserted and housed in the cup-holder opening 20 and the base 17 is visible on the outside, in particular when the cup-holder ring 19 is folded upwards in its housing as shown in FIG. 3 (the base 17 thus being in the plane of the backrest of the passenger seat supporting the cup-holder ring 19).

The hanging collar 12 extends radially above the cup-holder ring 19 which thus supports the hygiene accessory in accordance with the invention.

The various passenger seats of a public transport vehicle can be fitted with a hygiene accessory in accordance with the invention prior to embarkation of the passengers, each cup-holder ring 19 receiving a hygiene accessory in accordance with the invention. In a variation, or in combination, a hygiene accessory in accordance with the invention can be distributed to the passengers upon embarkation on board such a public transport vehicle.

In order to use the hygiene accessory in accordance with the invention the passenger for whom the cup-holder ring 19 is intended can unfold this ring 19 in order to place it in a horizontal position. The hanging collar 12 extends radially above the cup-holder ring 19 which thus supports the hygiene accessory in accordance with the invention. The passenger merely needs to pierce the frangible cover 15 with his finger in order to detach the base 17 from this cover 15 and cause the waste bag 14 to unfold downwardly into the state illustrated in FIG. 4. The frangible cover 15 being lifted off, the insertion aperture 13 is freed and allows insertion of waste into the waste bag 14 thus unfolded. The frangible cover 15 can be a simple polyethylene film provided with radial slits or perforations facilitating tearing thereof, e.g. fixed by high-frequency welding to the hanging collar 12.

It should be noted that if the insertion aperture 13 has a diameter greater than or equal to the diameter of the cup-holder opening 20 and if the waste bag 14 is sufficiently thin, a cup can be placed into the insertion aperture 13 (cf. FIG. 4) and held in place and supported by the cup-holder ring 19 in a conventional manner The cup thus closes the insertion aperture 13.

Advantageously, in the embodiment illustrated in FIGS. 4 and 5, the hanging collar 12 has teeth 21 extending radially, protruding towards the inside of said waste-insertion aperture 13. These teeth 21 can be triangular or rounded (e.g. in a half-disc shape) or of another shape. They permit a cup inserted into the insertion aperture 13 to be wedged in place. They facilitate removal of the unit formed by the cup and accessory in accordance with the invention from the cup-holder opening 20. In fact, it will suffice to grasp the cup and pull it upwards in order to remove the unit, the cup pulling the hanging collar 12 by means of the teeth. It should be noted in this respect that disposable cups are generally provided with peripheral horizontal grooves with which the teeth 21 can cooperate, producing a unit and holding the cup even more effectively.

The hanging collar 12 and the base 17 can be formed by a cut-out from a single disc-shaped piece, this cut-out permitting, if appropriate, the formation of said teeth 21 and permitting the base 17 to fit into the hanging collar 12 in the folded state (prior to unfolding of the bag 14).

After use, it is quick and easy to take the hygiene accessory in accordance with the invention out of the cup-holder opening 20 in the upwards direction in order to dispose of it. A hygiene accessory in accordance with the invention thus constitutes a disposable fitting which improves hygiene in passenger transport vehicles.

The dimensions of a hygiene accessory in accordance with the invention can be e.g. the following: diameter of the insertion aperture 13 (at the base of the teeth 21) and overall diameter of the base 17: 50 mm to 60 mm; outer diameter of the hanging collar 12: 70 mm to 90 mm; height of the waste bag 14 concertinaed below the hanging collar: 0.5 cm to 2 cm; height of the unfolded waste bag 14: 8 cm to 15 cm. Other dimensions are possible.

It should be noted that a hygiene accessory in accordance with the invention can also be placed in any cup-holder opening other than that of a foldable cup-holder opening, e.g. in a cup-holder opening provided in a foldable or retractable table or in an armrest or elsewhere.

1-15. (canceled)

16. Hygiene accessory for a passenger seat of a passenger-transport device comprising:
a waste container (14),
means (12) for hanging from a passenger seat, comprising a hanging collar (12) defining an aperture (13) for inserting waste, the waste container (14) being connected to the hanging collar (12) in such a way that it can be hung below the latter and receive waste introduced into said waste-insertion aperture (13),
the hanging collar (12) being adapted to be able to:
be held around an opening,
support the waste container (14) extending into said opening below said waste-insertion aperture,
wherein:
said means for hanging on a passenger seat are formed by said hanging collar (12)
the hanging collar (12) is adapted to be able to:
be held around an opening of a passenger seat,
support the waste container (14) extending into said opening of a passenger seat below said waste-insertion aperture,
the waste container (14) is kept folded up in an accordion-like fashion below the hanging collar (12) prior to use by a temporary attachment suitable for allowing it to unfold downwardly.

17. Hygiene accessory according to claim 16, wherein said hanging collar (12) is formed of at least one material selected from the group consisting of papers, card, non-woven textiles and polymers.

18. Hygiene accessory according to claim 16, wherein said hanging collar (12) is formed by a rigid circular planar washer.

19. Hygiene accessory according to claim 16, wherein said hanging collar (12) has a thickness of less than 3 mm.

20. Hygiene accessory according to claim 16, wherein said waste insertion aperture (13) is generally circular with a diameter greater than or equal to 70 mm.

21. Hygiene accessory according to claim 16, wherein said hanging collar (12) has teeth (21) extending radially, protruding towards the inside of said waste-insertion aperture (13).

22. Hygiene accessory according to claim 16, wherein said hanging collar (12) extends radially outwards from said waste-insertion aperture (13) by a radial extent of less than 90 mm.

23. Hygiene accessory according to claim 16, wherein the waste container (14) is sufficiently thin not to prevent insertion of a cup into said waste-insertion aperture (13) and into said opening.

24. Hygiene accessory according to claim 16, wherein the waste bag (14) is kept folded up in an accordion-like fashion prior to use by a temporary attachment of one end of the waste bag (14) below a frangible cover (15) fixed to said hanging collar (12) and covering said waste-insertion aperture (13) at least partially.

25. Hygiene accessory according to claim 16, wherein said waste bag (14) being kept folded up in an accordion-like fashion has a thickness of less than 2 cm.

26. Hygiene accessory according to claim 16, wherein the waste container collar (14) is a flexible bag.

27. Hygiene accessory according to claim 16, wherein the waste container (14) is formed of a flexible cylinder (16) closed by a base (17).

28. Hygiene accessory according to claim 27, wherein the base (17) has an overall diameter less than or equal to that of the waste-insertion aperture (13) and has visible printing.

29. Method for maintaining a passenger-transport device comprising passenger seats each fitted with at least one cup-holder opening, wherein a hygiene accessory according to claim 16 is made available to each passenger, and each hygiene accessory is collected after use.

30. Method according to claim 29, wherein before embarkation of the passengers a hygiene accessory is placed in each cup-holder opening (20).

31. Hygiene accessory according to claim 17, wherein said hanging collar (12) is formed by a rigid circular planar washer.

32. Hygiene accessory according to claim 17, wherein said waste insertion aperture (13) is generally circular with a diameter greater than or equal to 70 mm.

33. Hygiene accessory according to claim 18, wherein said waste insertion aperture (13) is generally circular with a diameter greater than or equal to 70 mm.

34. Hygiene accessory according to claim 19, wherein said waste insertion aperture (13) is generally circular with a diameter greater than or equal to 70 mm.

35. Hygiene accessory according to claim 17, wherein said hanging collar (12) has teeth (21) extending radially, protruding towards the inside of said waste-insertion aperture (13).
